(19) United States
(12) Patent Application Publication
(10) Pub. No.: US 2009/0045635 A1
(43) Pub. Date: Feb. 19, 2009

(54) BACKUP GENERATORS

(76) Inventor: MICHAEL PATRICK FLYNN, Rancho Santa Fe, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 12/188,068

(22) Filed: Aug. 7, 2008

Related U.S. Application Data
(60) Provisional application No. 60/955,587, filed on Aug. 13, 2007.

(51) Int. Cl. H02K 5/04

(52) U.S. Cl. 290/1 R

(57) ABSTRACT

A backup power generator unit for use with electronic equipment housed in an equipment cabinet, the cabinet having a top and a bottom, the bottom comprising attachment structure to attach the equipment cabinet to a base, the backup generator being housed in a backup generator cabinet having a top and a bottom substantially the same size as the top and bottom of the electronic equipment cabinet, the backup generator cabinet having attachment structure substantially similar to the attachment structure of the electronic equipment cabinet, so that the backup generator cabinet fits under the bottom or on the top of the electrical equipment cabinet and can be attached thereto.

This application claims the benefit of U.S. Provisional Application Ser. No. 60/955,587, filed Aug. 13, 2007, which application is incorporated herein by reference in its entirety.

### FIELD OF THE INVENTION

This invention relates to backup generators for electronic equipment, which do not require any additional land area for their placement. This includes electronic equipment at cell sites where equipment is located for cellular communication, sites for street lights, signal lights, cable installations, or the like.

### BACKGROUND OF THE INVENTION

Cell sites, street lights and signal lights, as well as other electronic equipment, are often located in very tight spaces, with little room for additional equipment. This is often because the land, or building space, is leased and expensive, so that only the minimum land or space needed for the equipment is leased.

A cell site is a location where antennas and other electronic equipment are located to provide a cell in a cellular network. Cell sites can be located in urban locations in or on buildings, but are also often located in rural areas, in order to provide cellular service to those areas.

Cell sites usually contain antennas and electronic communications equipment, such as one or more transmitter/receivers, Telco equipment, base transceiver stations, an electrical power source and a backup power source. Often the rural cell sites are not inside of a building and cabinets are used to house the equipment outdoors. The cabinets usually sit on a plinth, and/or sub-base, the cabinet base. The cell sites are usually placed on leased land. Traffic lights and signals also often have limited usable space.

In cell sites, The base transceiver stations (BTS) contain the equipment for transmitting and receiving radio signals and equipment for encrypting and decrypting communications with Base Station Controllers (BSC). Typically, a BTS will have several transceivers in order to serve different frequencies. There are usually a number of base transceiver stations at each cell site.

Power is supplied by standard commercial power provided by a local power company. Present installations have one backup generator in the cell site, in the event that the standard electrical power supply is cut off for any reason. This single backup generator, which may be a fuel cell, or other means of generating electricity, would supply power to the cell site for a limited period of time, the length of which depends upon the type of backup generator at the site. There is often little or no room for more than one backup generator (gen set).

### SUMMARY OF THE INVENTION

The present invention provides an improved system for backup power in the event that standard commercial power is interrupted at a site. The invention comprises a backup generator (gen set) for each and every key electronic piece of equipment located at the site. Thus, there would be multiple backup generators at the site and not just a single backup generator, as is now utilized.

Applicant's backup generators are each contained in a new cabinet which fits above or below each unit. Each cabinet would be designed to substantially match the connection method or pattern, such as a bolt pattern, of the base of each unit, so that the gen set backup generator would fasten to the connection method and pattern to which the unit was originally attached.

In cell sites, different manufacturers of BTS units, for different carriers, have different connection patterns and each gen set unit is designed so that the connection pattern matches the connection pattern of a specific BTS unit, so that it can be easily attached to the plinth and the BTS unit can then be attached to the top of the gen set cabinet. Alternatively, the gen set can be attached to the top of the BTS. There could also be a base/plinth having several different attachment methods, to allow different BTS units with different attachment methods, to be attached. The attachment method could be bolts or could be a bracelet or ring attachment.

The gen set of this invention can be placed under an existing BTS unit by removing the bolts, or other connectors, that hold the BTS unit in place, lifting it, placing the new gen set cabinet underneath it, bolting the gen set cabinet to the existing bolt system and then bolting the BTS unit to the top of the new gen set cabinet. The gen set could also be placed on the top of the BTS unit, if desired.

The cabinet is a fully integrated unit using, for instance, a propane tank incorporated into the unit, for fuel to create the backup electrical power. Instead of propane, a unit that uses diesel fuel could be utilized or one using natural gas, or the unit could be connected to a commercial utility providing natural gas and/or both commercial natural gas and on-site fuel storage.

In addition, the backup electrical power could be generated using a reciprocal or turbine fuel burning engine. Also, the electrical power could be generated by the use of a fuel cell, such as a hydrogen fuel cell. All of these backup power generating methods can be located in the gen set cabinet described above.

The advantage of Applicant's invention is that, instead of there being one backup generator for the entire installation, each and every BTS unit has its own backup generator, so that if regular commercial power is interrupted and/or shut off, each BTS unit, having its own backup power source, would continue to operate. If any of the backup power units also failed, there is a redundancy in having a multiple number of backup power units, so that some of the BTS units would still operate and the cell site can continue to operate.

Another advantage of Applicant's system is that no new land area needs to be purchased or leased to hold backup power generators. Each gen set unit fits directly underneath, or on the top of, each BTS unit, so that no new lease area is required and the “footprint” of the existing site is not increased.

### BRIEF DESCRIPTIONS OF THE DRAWINGS

FIG. 1 is a depiction of a cell site;

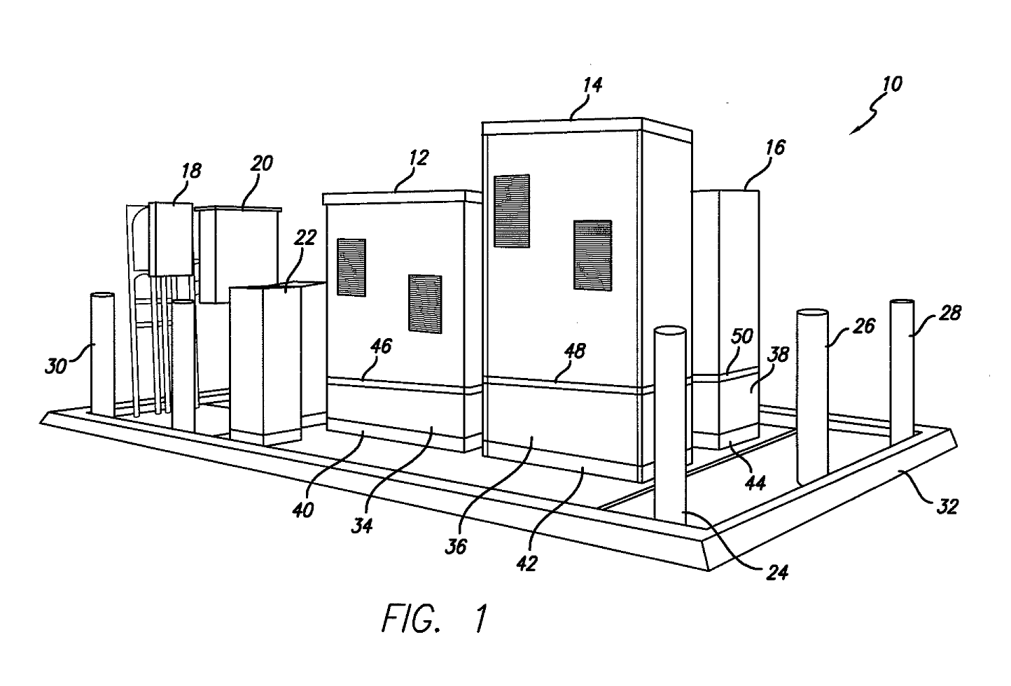

FIG. 2 is a depiction of a BTS cabinet with a gen set backup power unit placed underneath a BTS cabinet.

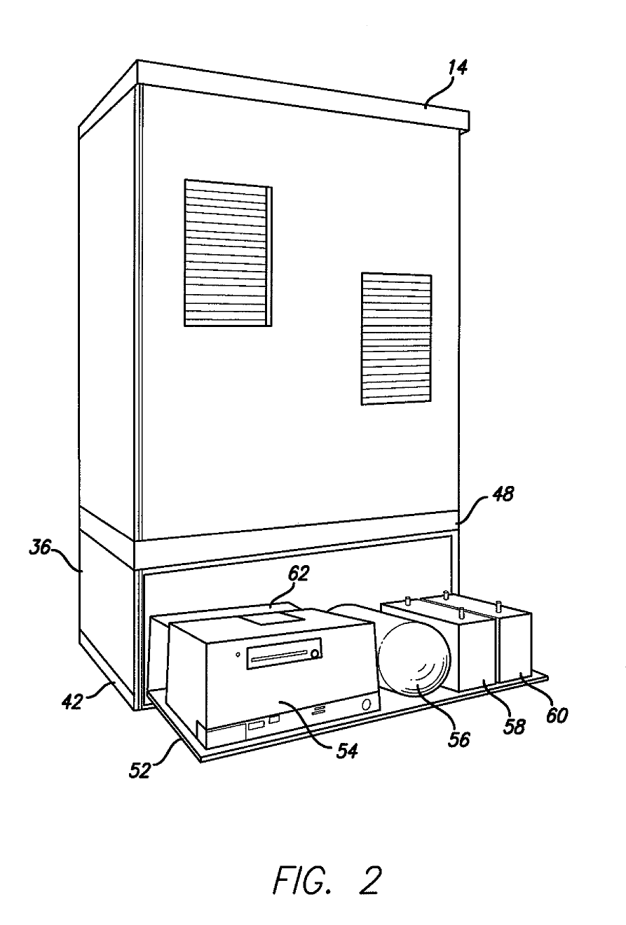

### DETAILED DESCRIPTION OF THE INVENTION

Referring now to the drawings there is shown a typical outdoor cell site 10, having three base transceiver stations (BTS) 12, 14 and 16. Telco equipment is contained in cabinet 20 and breakers/disconnects are located in cabinet 18. A power cabinet 22 holds the input power equipment to normally power the standard wireless cell site configuration.

A series of columns 24, 26, 28 and 30 are present to protect the equipment cabinets from impact damage. A base 32 on which all of the equipment cabinets are placed, defines the “footprint” or lease area of the cell site.

Using propane as the fuel, the tanks are the same as the existing design used on motor homes or barbeques.

Each of the BTS stations 12, 14 and 16 have a gen set cabinet 34, 36 and 38 placed between the sub-base 40, 42 and 44 of each unit and the BTS stations 12 14 and 16. The gen set cabinets 34, 36 and 38 are bolted to the sub-bases 40, 42 and 44 and the BTS cabinets 12, 14 and 16 are bolted to the top of the gen set cabinets 34, 36 and 38 at connections 46, 48 and 50. The bolt pattern of both connections, base to gen set and gen set to BTS is the same. The gen set cabinets could be put in place when the cell site was originally constructed or they could have been added later by unbolting each BTS unit, lifting it up, bolting the gen set cabinet to the base and then bolting the BTS unit to the top of the gen set cabinet.

Each gen set cabinet has a slide-out shelf 52 which provides ease of access to the inside of the gen set cabinet. On the shelf 52 is located the electrical generator 54, the fuel tank 56 and batteries 58 and 60. Usually, there are four 12 volt batteries. An automatic transfer switch 62 detects a loss of electrical power from the primary systems and turns on the gen set backup power system.

The batteries 58 and 60 are present to operate the automatic transfer switch and to power the transition period from when commercial power stops to when the gen set starts running.

Using propane, the tanks are the same as the existing design used by motor homes or barbeques. Diesel tanks are similar to those used by motor homes and other diesel powered generators.

The slide-out shelf also allows easy access to refill or simply replace the fuel tanks. The operation technicians can simply carry replacement tanks, dramatically reducing fueling costs and fueling during disasters. The tanks, if needed, are double insulated to meet hazmat requirements. On open land sites the cabinets could be linked to large propane or diesel tanks. The slide-out shelf also allows for easy replacement of any of the gen set parts for preventative maintenance and/or gen set “switch outs” for offsite gen set maintenance, to reduce maintenance costs.

### ADVANTAGES OF APPLICANT'S GEN SET SYSTEM

1. It utilizes no new lease area, which results in great savings in terms of what the carriers would otherwise have to pay for additional lease area.

2. Limited gen set size and fuel supply assists, if not circumvents, entitlement/jurisdictional/hazardous material/fire issues when placing gen sets on sites.

3. The genset units are designed to be “interchangeable” with existing plinths to allow quick and inexpensive installs which use the same bolt patterns of existing outdoor sub-bases and radio cabinets, of the current outdoor radio cabinet manufacturers, such as, Lucent, Ericson, etc.

4. Modularity of the gen set and its fuel supplies to allow “remove and service” availability and fueling replacement by “container/tank” rotation in lieu of a fuel truck or special vendor. The carriers own operations technicians can use special dollies to carry replacement gen sets and fuel replenishment containers/tanks. These smaller fuel supplies may eliminate other jurisdictional issues.

5. The concept of placing gen sets on each individual radio cabinet allows redundancy, if one or more of the individual gen sets fail to work. Unlike large gen sets running a number of cabinets, when that gen set fails to initiate, the site completely goes down. Gen sets can be made available for placement under/over each radio cabinet for those outdoor sites with a number of individual cabinets and a “stackable” set-up for sites where gen sets need to be separate from the radio cabinets and/or for shelter sites where there would be a method of stacking modular gen sets on top of each other to operate a number of remotely placed outdoor cabinets not inducive to placing a gen set on each cabinet, or shelter locations with indoor radio cabinets within the shelter.

6. Each gen set would have a slide-out drawer for access to the fuel and the gen set.

7. Each gen set would have “heat protection” for the radio equipment and for the coaxial cable. The gen set can be alarmed and remotely monitored/controlled via connections within the radio cabinet (most if not all radio cabinets are linked via an alarm to the carrier's operations center).

8. The use of biodiesel will provide a “green solution”, as well as receive tax credits, and incentives. Currently there are tax credits for using “green fuels” to, not only offset fuel costs, but also provide tax credits for the actual cost of the gen set. The size of these gen sets also allow for benefits associated with Clean Air Environmental requirements, permitting, etc., associated with gen set placement.

9. The use of this independent radio backup power plant allows for a fuel supply on site without many, if any, of the hazmat and/or fire regulations of full generator installations, which require a large fuel supply on site.

A fire suppression system could optionally be placed into the gen set cabinet, for safety purposes.

There could also be a natural gas feed to the cell site which could provide a feed to the gen set units in the event of a primary power failure.

The fuel tanks could have “quick disconnect” fittings for easy removal and replacement.

Soundproofing can be provided for the cabinets as well as anti-vibration fittings.

An alarm system could be provided in each gen set cabinet, which also could provide remote monitoring and alerts, as to fuel levels, battery levels, malfunctions, etc.

Having thus described the invention, I claim:

1. A backup generator unit for use with electronic equipment housed in an:
equipment cabinet, said cabinet having a top and a bottom, the bottom comprising attachment structure to attach the equipment cabinet to a base, the backup generator being housed in a backup generator cabinet having a top and a bottom substantially the same size as the top and bottom of the electronic equipment cabinet, the backup generator cabinet having attachment structure substantially similar to the attachment structure of the electronic equipment cabinet, so that the backup generator cabinet fits under the bottom or on the top of the electrical equipment cabinet and is attached thereto.

2. The backup generator unit of claim 1 in which the attachment structure comprises a pattern of bolts.

3. A method for providing backup power for a wireless cell site comprising a plurality of transceiver units comprising placing a backup generator unit underneath, or on top of, each transceiver unit, said backup generator adapted to power the transceiver unit in the event of a power failure of the primary power supply.

4. A method for providing backup power for an electronic installation comprising a plurality of electronic units comprising placing a backup generator unit underneath, or on top of, each electronic unit, said backup generator adapted to power the electronic unit in the event of a power failure of the primary power supply.

5. The method of claim 5 in which each backup generator unit is removably attached to the electrical unit.

6. The backup generator unit of claim 1 in which the backup generator cabinet bottom comprises a plurality of different attachment structures.

7. The backup generator unit of claim 1 in which the backup generator is placed on a slide-out shelf.

8. The backup generator unit of claim 1 in which each backup generator unit has its own fuel supply.

9. The backup generator unit of claim 1 in which the fuel supply comprises propane, natural gas, or diesel fuel.

10. The backup generator unit of claim 1 in which each unit is placed between the electronic equipment cabinet and the electronic equipment cabinet base.

11. The backup generator method of claim 4 in which a plurality of backup generator units are stacked on top of each other.

12. The backup generator units of claim 1 in which each unit further comprises heat protection structure for protection of the electrical equipment.

13. The backup generator units of claim 1 in which each unit further comprises a fire suppression system.

14. The backup generator units of claim 1 in which each unit further comprises quick disconnect fittings for easy removal and replacement of parts.

15. The backup generator units of claim 1 further comprising a remote monitoring system for each unit.

16. The backup generator units of claim 1 further comprising soundproofing for each unit

17. The backup generator units of claim 1 further comprising means to damper vibration in each unit

18. The backup generator units of claim 1 in which the backup generator units are fuel cells.

19. The backup generator units of claim 1 in which the backup generator units are reciprocal or turbine fuel burning engines.
